(19) United States
(12) Patent Application Publication
(10) Pub. No.: US 2015/0030777 A1
(43) Pub. Date: Jan. 29, 2015

(54) CONCRETE CURING PRODUCT AND METHOD OF USE

(71) Applicant: THE BOARD OF REGENTS FOR OKLAHOMA STATE UNIVERSITY, STILLWATER, OK (US)

(72) Inventors: Matthew Tyler Ley, Stillwater, OK (US); Kristopher Jacob LeFlore, Glencoe, OK (US); Travis Gregory Ebisch, Edmond, OK (US)

(73) Assignee: The Board of Regents for Oklahoma State University, Stillwater, OK (US)

(21) Appl. No.: 14/380,205

(22) PCT Filed: Feb. 28, 2013
(86) PCT No.: PCT/US13/28256

§ 371 Date: Aug. 21, 2014

Related U.S. Application Data
(60) Provisional application No. 61/604,322, filed on Feb. 28, 2012.

(51) Int. Cl. C04B 41/48

(52) U.S. Cl. CPC C04B 41/4803
USPC 427/393.6; 106/162.9

(57) ABSTRACT

A mixture includes a pulped solid material, water, a viscosity modifier, and a dye. The solid material, water, viscosity modifier, and dye are mixed to form a slurry that will adhere in a layer onto a freshly finished concrete structure for purposed of aiding in curing the concrete.

### CROSS REFERENCE TO RELATED APPLICATION

This application claims the benefit of U.S. Provisional Application No. 61/604,322 filed Feb. 28, 2012, herein incorporated by reference in its entirety for all purposes.

### FIELD OF THE INVENTION

This disclosure relates to products and methods for aiding in curing concrete in general and, more particularly, to a product and method of curing concrete utilizing an applied pulp mixture.

### BACKGROUND

Concrete structures and components utilized for certain critical applications, such as highways or bridge decks, are typically required by the relevant owners (e.g., state highway departments) to have a minimum cure time. Some owners require seven to fourteen days of cure time in order to promote hydration of the concrete to produce a strong and dense microstructure.

In the past, techniques to aid in concrete curing included water spraying, wet blanket covers, low and high-pressure steam, and others. The costs required to provide these types of curing can be high. For example, it is quite labor intensive to cover fresh concrete with wet cloth or burlap, and then to with tarps. Because the surface of the concrete must be kept moist, the tarps must be removed so that water trucks can visit the site to re-wet the materials used, upon which the tarps must be replaced. This process serves to further increase costs.

What is needed is a system and method for addressing the above, and related, concerns.

### SUMMARY

The invention of the present disclosure, in one aspect thereof, comprises a mixture of a pulped solid material, water, a viscosity modifier, and a dye. The solid material, water, viscosity modifier, and dye are mixed to form a slurry that will adhere in a layer onto a freshly finished concrete structure for purposed of aiding in curing the concrete. The dye indicates a degree of dryness of the mixture.

In some embodiments, the solid material comprises between 4% and 6% of the mixture by weight. The water may comprise between 92% and 96% of the mixture by weight. In another embodiment, The solid material comprises about 6% of the mixture by weight and the water comprises about 94% of the mixture by weight.

The pulped solid material may comprise cellulose and/or a recycled material. The viscosity modifier may comprise about 0.2% of the mixture by weight and may be guar gum or another starch based material.

The dye may appear as a darker color in the mixture at a higher moisture level. In other embodiments, the dye changes color as the mixture loses moisture. The dye may be a food safe dye. In some embodiments, the dye may comprise basic dye, monoazo, triphenylmethane dyestuff, and/or methine dyestuff

Additional additives may include an evaporation reducing additive, such as a hummic acid compound.

The invention of the present disclosure, in another aspect thereof, comprises a mixture containing a solid portion including a pulped cellulosic solid, a liquid portion including water and a dye, and a viscosity modifier that increases the viscosity of the mixture to the extent necessary to allow it to be applied in a layer to a concrete structure. The dye indicates the relative level of moisture remaining in the applied mixture with a color change as the mixture changes from a higher level of moisture to a lower level of moisture. The mixture may also contain an evaporation reducing additive.

In some embodiments, the viscosity modifier comprises guar gum at a concentration of about 0.19% by weight. Water may comprise about 93.65% of the mixture by weight, while the pulped cellulosic solid comprises about 6.17% of the mixture by weight. In another embodiment, the solid material comprises between 4% and 6% of the mixture by weight while the water comprises between 92% and 96% of the mixture by weight.

In some embodiments, an intensity of the dye indicates a depth of coverage by the mixture.

The invention of the present disclosure, in another aspect thereof, comprises, a method including providing a pulp mixture including at least 90% by dry weight of a cellulosic pulp, mixing the pulp mixture with water to form a slurry, adding a dye to the slurry, and applying a layer of the slurry to an uncured concrete structure and leaving it in place during at least a portion of the curing process. During the portion of the curing process that the applied slurry is in place, the current relative moisture level of the applied slurry may be observed as a darker color of the dye indicating a higher moisture level and a lighter color of the dye indicating a lower moisture level.

The method may also include rewetting the applied slurry during the portion of the curing process where the applied slurry is in place and/or adding an evaporation reducer to the slurry before applying it to the concrete structure.

### BRIEF DESCRIPTION OF THE DRAWINGS

FIG. 1 is a schematic overview of the formulation and application of a concrete curing mixture according to aspects of the present disclosure.

FIG. 2 is a time-lapse view of one embodiment of a concrete curing product of the present disclosure during the curing process.

FIG. 3 is a graph of water loss over time for a concrete curing product of the present disclosure versus burlap and water.

FIG. 4 is a graph of water loss over time for various formulations of the present disclosure.

### DETAILED DESCRIPTION OF THE PREFERRED EMBODIMENTS

According to the present disclosure, various materials and methods are provided for use in the concrete curing process. Referring now to FIG. 1, a schematic overview 100 of the formulation and application of a concrete curing mixture according to aspects of the present disclosure is shown. In one embodiment, a predetermined amount of solids 104 are mixed with a predetermined amount of water 102 to create a mixture 110 that may be applied to freshly finished concrete 114 to aid in the concrete curing process. The mixture 110, applied in a layer 116 as described more fully below provides a moisture barrier for the concrete structure 114 as it cures. The layer 116 also helps keep the various parts of the structure 114 closer to the same temperature during curing. Having a constant moisture and temperature while being somewhat protected from the environment promotes optimal curing of concrete structures.

In one embodiment, the solids 104 comprise paper pulp. Various types of paper pulp and other materials may be used for the solids 104. For example, pulped newsprint, drill paper, wood, corncobs, cottonseed hulls, straw, and coco hulls may all be utilized. Various other high cellulose or natural materials may also be used. Regardless of the starting material, it will be finely ground or crushed. It will also be appreciated that an opportunity exists for the use of various recycled products as the source of pulp for embodiments of the present disclosure.

The water 102 may be purified, but it is not necessary. The water 102 need only be free enough of impurities so as not to damage the pulp 104 or concrete (e.g., it should not be overly basic or acidic), or interfere with the admixtures discussed below. The water 102 could be from a public water supply or a natural water source closely available such as an irrigation pond or a river.

One or more admixtures 106 may be supplied to the mixture 110 in relatively small amounts. In one embodiment, the admixture 106 comprises a viscosity modifier or tackifier. Various products may be utilized to fulfill the function of the tackifier, namely, to increase the viscosity and adhesive properties of the mixture 110 allowing it to be sprayed or poured onto a finished concrete surface and form a somewhat adhesive layer that will remain in place during the curing process. It should be understood though that although the mixture 110 is somewhat adherent, or has the ability to tack on to a concrete surface, it is not bonded to the surface itself. In fact, ease of removal is another attribute of the mixture 110.

In various embodiments, the viscosity modifier may comprise guar gum, or Enviro-Tak® available from Central Fiber, LLC of Wellsville, Kans.

It will be appreciated that a wide array of viscosity modifiers or tackifiers exist, and many may be useful with the products and methods of the present disclosure depending upon cost and availability. Tackifiers used in the hydromulching industry are often useful for the purposes of the present disclosure. These may be based on starch, corn, synthetic starches or other materials.

Some embodiments of the present disclosure also include a dye 108 added to the mixture 110. The dye 108 imparts a color to the mixture 110 that changes over time as the moisture content of the applied mixture 116 changes. Thus any dye that has these properties and does not adversely affect the concrete or interfere with any of the other admixtures being used may be suitable. The color change of the dye 108 may be from darker to lighter (or vice versa) as the layer 116 loses or gains moisture. The color change may also be from one color to another (e.g, from orange to red) with the use of a moisture sensitive dye. In some embodiments, the dye 108 will be provided as a liquid or suspension. In other embodiments, the dye 108 may be provided in a powdered form, or other dry form.

Another use for the dye 108 is to ensure even coverage of the applied mixture 116. The color of the layer 116 may appear less intense in areas where coverage is insufficient. Thus, the worker applying the layer may be able to remedy the insufficient coverage at the time the layer 116 is applied to the structure 114.

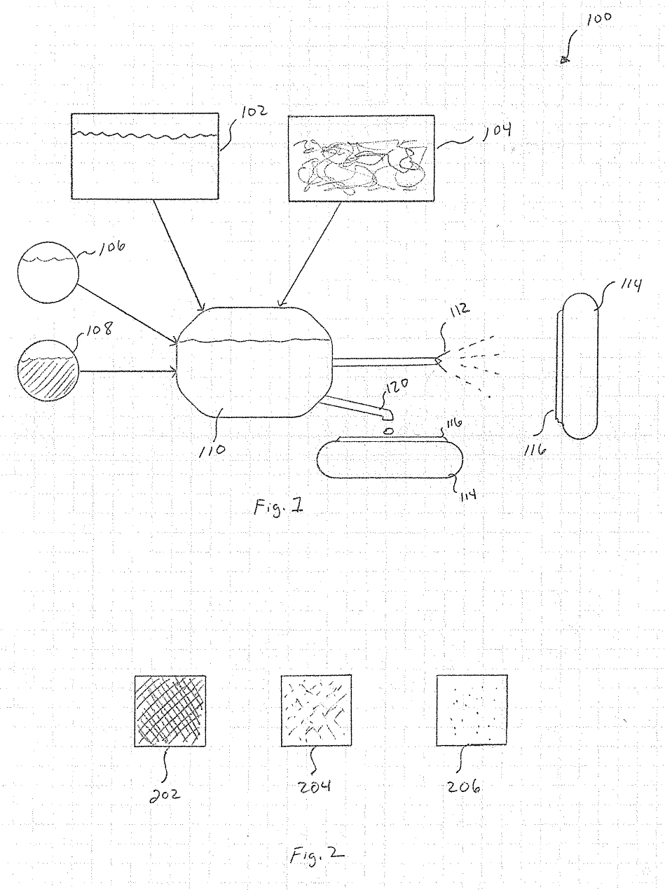

Referring now to FIG. 2 is a time-lapse view of the mixture applied to a concrete surface as the mixture dries resulting in a lightening of the dye indicating the relative moisture level. 202 shows the freshly applied mixture having a relatively dark color. An intermediate stage is shown at 204 where a portion of the water has evaporated from the mixture giving a lighter color. 206 illustrates a relatively dry mixture where the dye 108 provide little color to the mixture. In addition to providing an indication as to the progress of the curing, the dye mixture can also provide an indication of whether or not rewetting is necessary. Thus, unneeded water transportation and application can be avoided.

In various embodiments, the dye 106 may be a dye manufactured by Standard Dyes, Inc. of High Point, N.C. The specific dye may be from the Permacryl® line which is available in various colors that may be useful in the present application such as Auramine OO, Chrysodine Y Ex Conc., Bismark Brown R, Rhodamine B, Methyl Violet 2B, Victoria Pure Blue BO, Green Powder, and possibly others. The Permalite® line is also available in various useful colors such as Yellow G 200%, Yellow 4G, Yellow DM, Yellow 2RLSW, Orange SE Ex., Scarlet 4SWN, Scarlet CAS, Red 8BL, Brilliant Pink BR, Turquoise 8GL, Bond Blue BNE, Blue 8GLL, Blue FFC, Black E-SE Ex, and possibly others. These have basic dye, monoazo, triphenylmethane dyestuff, and/or methine dyestuff as the chemical family per the relevant material safety data sheet.

It will be appreciated that in some embodiments, the dye 108 is a basic food dye. Such dyes are safe for the environment and can be made biodegradable. Hence, the use of dye 108 does nothing to cause toxicity of the mixture 110, which saves money as it can safely be handled, recycled, and/or disposed of without special safety equipment.

In addition to the viscosity modifier 106 and the dye 108, additional admixtures may be utilized to provide for different performance features. For example, additives may be used to improved pumpability of the mixture 110. It may be desirable to utilize an additive for slowing desorption of water from the exposed surface of the pulp fibers. Alcohols such as isopropyl alcohol, ethanol, methanol, or others may be used to reduce surface tension of the water in the mixture 110 making the water evaporate as a slower rate. Additionally, if a long chain alcohol is used it may stay in place on the concrete structure 114 after curing is complete and the layer 116 is removed. Hummic acid compounds such as Hydretain® available from Ecologel Solutions, LLC of Ocala, Fla. in liquid or solid form may be used for slowing desorption as well. Test data indicates that additives can be added to change the rate of water evaporation without harming the concrete.

It will be appreciated the ratios of the major ingredients (where the term major is understood to mean the most prevalent, not necessarily the most important) may vary according to the environment, temperature, cure time needed, etc. In one embodiment, the mixture 110 comprises about 94% water (by weight) and about 6% solids 104. Less than 1% will normally be needed of the tacking agent/viscosity modifier 106. The dye may be added to the mixture at a concentration of about 1 gram per liter of water. In one embodiment, the final mixture 110 comprises 93.65% water, 6.17% solids, and 0.19% viscosity modifier 106, all by weight, with dye added at the rate of 1 g/L. Where other admixtures are used, they may be in amounts that are relatively minimal compared to the solids 104 and water 102. It will also be appreciated that the percentages here include the weight of water 102 in the mixture 110. Absent the water, the solids 104 will comprise 90% or more of the product.

It will be appreciated the percentages of solids 104 and water component 102 vary according to the embodiment. For example, in some embodiments, the water 104 varies from 92% to 96%. The solids 104 vary from 4% to 7%.

The mixture 110 can be prepared such that rewetting on the structure 114 is not necessary. Actual performance can vary with the conditions. For example, a hot, dry climate may be more demanding on the mixture 110 than a mild climate. To a degree, compensation can be made for various climates by increasing the amount of water 102 and tackifier 106 in the mixture 110. However, even where sufficient alterations cannot be made to the mixture to prevent the need to rewet it entirely over the course of the concrete cure, improvements in performance will still be realized over existing technology as demonstrated in the provided data below. Furthermore, at current market prices, the mixture 110 of the present disclosure can be applied to a surface at about half the cost of a traditional wetted burlap cover.

The mixture 110 may be prepared in numerous ways, including but not limited to mechanical agitation or mixing with a recirculating pump. In some embodiments, mechanical agitation can mix the materials in about ten minutes, while recirculating pumps can take about thirty minutes. These times may be decreased with the use of greater amounts of water in the mixture.

The mixture 110 may be prepared and transported to a work site, or may be prepared on location where it is to be used. In various embodiments, the mixture 110 is pumpable and may be applied under pressure via a nozzle 112 or applied to the surface of the structure 114 via pipe or hose 120.

In use, the wet mixture or slurry 110 is applied directly to a finished concrete surface 114. The slurry 110 is applied to form a layer 116 on the surface 114. The thickness of the layer 116 may vary depending upon application and formula but in one embodiment it is about 0.75 inches thick, which provides good protection for the concrete during curing, while minimizing labor to apply the mixture 110. A 40-pound bale of solids 104 may produce about 6.25 cubic feet of the mixture 110, with 0.75 inches of coverage for around 100 square feet of concrete surface 114 can be covered. In commercial applications this amount of mixture can currently be applied over a ten foot distance in less than one minute. In other embodiments, a shallower layer 116 may be laid down (e.g., 0.5 inches), which means an even larger amount of area can be applied in the same time.

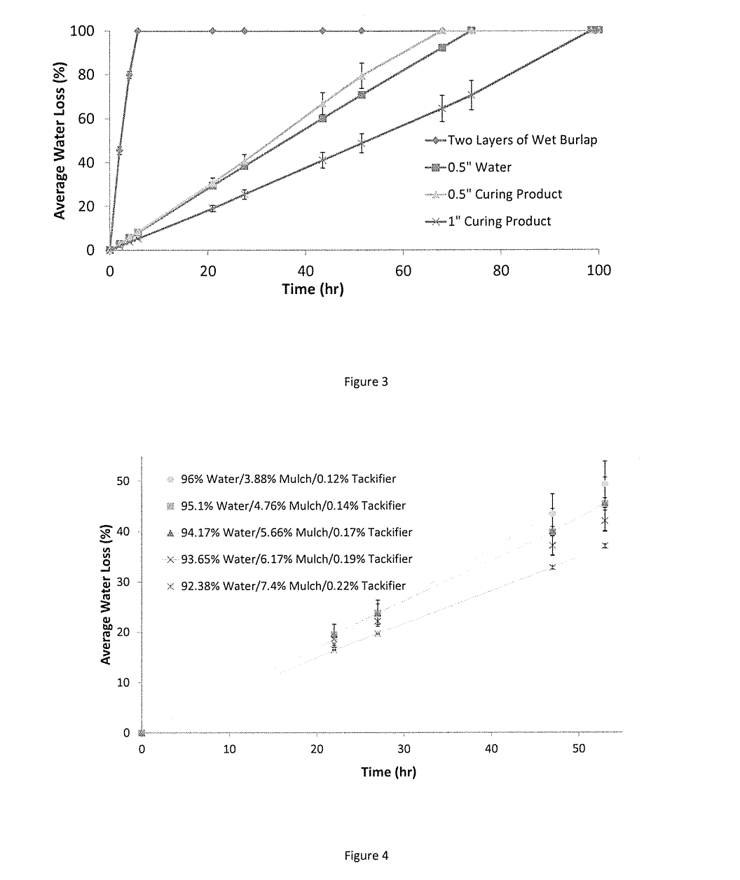

Referring now to FIG. 3 is, graph of water loss over time for a concrete curing product of the present disclosure versus burlap and water is shown. The mixture 110 was prepared with 6.17% solids, 93.65% water, and 0.19% viscosity modifer by weight. The mixture was prepared for testing by providing 0.5 and 1-inch thick samples. The samples were placed in a chamber at 73 degrees Fahrenheit and 40% relative humidity. Also placed in the chamber were a 0.5-inch deep water sample, and a two layer burlap sample saturated with water. Average percentage of water loss over time is shown in FIG. 3. The bars at the data points indicate one standard deviation. It can be seen that the wet burlap lost all water in less than 20 hours. The 0.5 inch sample of the mixture 110 had a moisture loss rate on par with the 0.5 inch sample of water. The 1 inch sample had even better performance and retained measurable levels of moisture until around 100 hours. Thus, the particular embodiment tested, the mixture 110 of the present disclosure provided performance that met or exceeded standard wet burlap but at a fraction of the cost.

It will also be appreciated that the solids in the mixture 110 act to hold the water component in contact with the concrete where it will be most effective. No additional damming products are needed, as would be the case to keep a water barrier in place at the depth needed to be effective.

Referring now to FIG. 4 a graph of water loss over time for various formulations of the present disclosure is shown. The data was generated by placing the various samples in a test chamber at 73 degrees Fahrenheit and 40% relative humidity. The bars at the data points indicate one standard deviation. It can be seen, that generally, as less mulch (solids 106) is used, water loss as a percentage becomes greater. However, as mentioned above, there are additional concerns and requirements for the mixture 110 such as pumpability.

### REFERENCES

IBISWorld. (September 2011). 23811-CONCRETE CONTRACTORS IN THE US. In Industry Outlook. Retrieved Oct. 4, 2011, from www.ibisworld.com.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A mixture comprising:
a pulped solid material;
water;
a viscosity modifier; and
a dye;
wherein the solid material, water, viscosity modifier, and dye are mixed to form a slurry that will adhere in a layer onto a freshly finished concrete structure for purposed of aiding in curing the concrete; and
wherein the dye indicates a degree of dryness of the mixture.

2. The mixture of claim 1, wherein the solid material comprises between 4% and 6% of the mixture by weight.

3. The mixture of claim 1, wherein the water comprises between 92% and 96% of the mixture by weight.

4. The mixture of claim 1, wherein the solid material comprises about 6% of the mixture by weight and the water comprises about 94% of the mixture by weight.

5. The mixture of claim 1, wherein the pulped solid material comprises cellulose.

6. The mixture of claim 1, wherein the pulped solid material comprises a recycled material.

7. The mixture of claim 1, wherein the viscosity modifier comprises about 0.2% of the mixture by weight.

8. The mixture of claim 1, wherein the viscosity modifier comprises guar gum.

9. The mixture of claim 1, wherein the dye appears as a darker color in the mixture at a higher moisture level.

10. The mixture of claim 1, wherein the dye changes color as the mixture loses moisture.

11. The mixture of claim 1, wherein the dye is a food safe dye.

12. The mixture of claim 1, wherein the dye is selected from the group consisting of basic dye, monoazo, triphenylmethane dyestuff, and methine dyestuff.

13. The mixture of claim 1, further comprising an evaporation reducing additive.

14. The mixture of claim 13, further comprising a hummic acid compound.

15. A mixture comprising:
a solid portion including a pulped cellulosic solid;
a liquid portion including water and a dye; and
a viscosity modifier that increases the viscosity of the mixture to the extent necessary to allow it to be applied in a layer to a concrete structure;
wherein the dye indicates the relative level of moisture remaining in the applied mixture with a color change as the mixture changes from a higher level of moisture to a lower level of moisture.

16. The mixture of claim 15, further comprising an evaporation reducing additive.

17. The mixture of claim 15, wherein the viscosity modifier comprises guar gum at a concentration of about 0.19% by weight.

18. The mixture of claim 15, wherein the water comprises about 93.65% of the mixture by weight.

19. The mixture of claim 15, wherein the pulped cellulosic solid comprises about 6.17% of the mixture by weight.

20. The mixture of claim 15, wherein the solid material comprises between 4% and 6% of the mixture by weight.

21. The mixture of claim 15, wherein the water comprises between 92% and 96% of the mixture by weight.

22. The mixture of claim 15, wherein an intensity of the dye indicates a depth of coverage by the mixture.

23. A method comprising:
providing a pulp mixture including at least 90% by dry weight of a cellulosic pulp;
mixing the pulp mixture with water to form a slurry;
adding a dye to the slurry; and
applying a layer of the slurry to an uncured concrete structure and leaving it in place during at least a portion of the curing process;
wherein during the portion of the curing process that the applied slurry is in place, the current relative moisture level of the applied slurry may be observed as a darker color of the dye indicating a higher moisture level and a lighter color of the dye indicating a lower moisture level.

24. The method of claim 23, further comprising rewetting the applied slurry during the portion of the curing process where the applied slurry is in place.

25. The method of claim 23, further comprising adding an evaporation reducer to the slurry before applying it to the concrete structure.
